(19) United States
(12) Patent Application Publication
(10) Pub. No.: US 2026/0170605 A1
(43) Pub. Date: Jun. 18, 2026

(54) MULTISPECTRAL DEMOSAICING VIA DUAL CAMERAS

(71) Applicant: SAMSUNG ELECTRONICS CO., LTD., Suwon-si (KR)

(72) Inventors: SaiKiran Tedla, North York (CA); Junyong Lee, Oakville (CA); Michael Brown, Toronto (CA); Mahmoud Afifi, North York (CA)

(73) Assignee: SAMSUNG ELECTRONICS CO., LTD., Suwon-si (KR)

(21) Appl. No.: 19/416,772

(22) Filed: Dec. 11, 2025

Related U.S. Application Data
(60) Provisional application No. 63/735,796, filed on Dec. 18, 2024.

(51) Int. Cl. G06T 3/4015; G06T 5/50; H04N 23/84; H04N 23/90

(52) U.S. Cl. CPC G06T 3/4015; G06T 5/50; H04N 23/843; H04N 23/90; G06T 2207/10024; G06T 2207/20221

(57) ABSTRACT

A method performed by at least one processor of an electronic device include capturing a first mosaic image through a first camera of the electronic device for a target scene; capturing a second mosaic image through a second camera of the electronic device for the target scene; obtaining a first demosaiced image based on the first mosaic image; obtaining a second demosaiced image based on the second mosaic image; estimating a cross-spectral disparity between the first demosaiced image and the second demosaiced image; and generating a third demosaiced image based on the first demosaiced imaged, the second demosaiced image, and the cross-spectral disparity.

### CROSS-REFERENCE TO RELATED APPLICATION

This application claims the benefit of U.S. provisional application No. 63/735,796 filed on Dec. 18, 2024, the entire contents of which are incorporated herein by reference.

### BACKGROUND

### 1. Field

This disclosure is directed to multispectral demosaicing via dual cameras.

### 2. Related Art

Multispectral (MS) images capture detailed scene information across a wide range of spectral bands, making them invaluable for applications requiring rich spectral data. Integrating MS imaging into multi-camera devices, such as smartphones, has the potential to enhance both spectral applications and RGB image quality. A critical step in processing MS data is demosaicing, which reconstructs color information from the mosaic MS images captured by the camera.

MS imaging extends beyond standard RGB imaging by capturing spectral information across multiple wavelengths, often including visible and near-infrared spectra. MS imaging enables precise analysis for applications such as agriculture, medical imaging, and environmental monitoring. MS data has also shown great potential for image enhancement and color reproduction, making it a valuable addition to imaging pipelines.

As multi-camera systems become more common in modern smartphones, interest in integrating MS and RGB imaging has increased to leverage additional spectral data that can complement RGB images. While hyperspectral (HS) images provide denser and more contiguous spectral information than MS images, MS sensors are more practical for mobile devices, as HS imaging typically requires expensive and time-consuming capture systems.

In turn, there has been growing research focused on incorporating MS sensors into mobile devices, demonstrating their ability to enhance performance in mobile RGB imaging tasks such as illuminant spectral estimation image restoration, low-light enhancement and tone adjustment. However, most methods leverage MS imaging as a complementary tool prior to improving RGB-targeted tasks rather than focusing on enhancing MS image quality directly. This features is primarily due to the lower fidelity typically associated with the MS imaging pipeline.

### SUMMARY

According to an aspect of the disclosure, a method performed by at least one processor of an electronic device includes capturing a first mosaic image through a first camera of the electronic device for a target scene; capturing a second mosaic image through a second camera of the electronic device for the target scene; obtaining a first demosaiced image based on the first mosaic image; obtaining a second demosaiced image based on the second mosaic image; estimating a cross-spectral disparity between the first demosaiced image and the second demosaiced image; and generating a third demosaiced image based on the first demosaiced imaged, the second demosaiced image, and the cross-spectral disparity.

According to an aspect of the disclosure, an electronic device includes: memory storing one or more instructions; a processor operatively coupled to the memory, in which the instructions, when executed by the processor, cause the electronic device to: capture a first mosaic image through a first camera of the electronic device for a target scene; capture a second mosaic image through a second camera of the electronic device for the target scene; obtain a first demosaiced image based on the first mosaic image; obtain a second demosaiced image based on the second mosaic image; estimate a cross-spectral disparity between the first demosaiced image and the second demosaiced image; and generate a third demosaiced image based on the first demosaiced imaged, the second demosaiced image, and the cross-spectral disparity.

According to an aspect of the disclosure, a non-transitory computer readable medium having instructions stored therein, which when executed by a processor in an electronic device cause the electronic device to perform a method including: capturing a first mosaic image through a first camera of the electronic device for a target scene; capturing a second mosaic image through a second camera of the electronic device for the target scene; obtaining a first demosaiced image based on the first mosaic image; obtaining a second demosaiced image based on the second mosaic image; estimating a cross-spectral disparity between the first demosaiced image and the second demosaiced image; and generating a third demosaiced image based on the first demosaiced imaged, the second demosaiced image, and the cross-spectral disparity.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates an example dual camera setup, an example MS demosaicing process, and an example demosiacing process using the dual camera setup, in accordance with embodiments of the present disclosure.

FIG. 4 illustrates example sensors, in accordance with embodiments of the present disclosure.

FIG. 5 illustrates an example demosaicing framework, in accordance with embodiments of the present disclosure.

FIG. 6 illustrates an example MS demosaicing process, in accordance with embodiments of the present disclosure.

FIG. 7 illustrates an example MS demosaicing process, in accordance with embodiments of the present disclosure.

FIG. 8 illustrates an example MS demosaicing process, in accordance with embodiments of the present disclosure.

FIG. 9 illustrates an example process for generating an MS demosaiced image, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Multispectral (MS) images capture detailed scene information across a wide range of spectral bands, making them invaluable for applications requiring rich spectral data. Integrating MS imaging into multi-camera devices, such as smartphones, has the potential to enhance both spectral applications and RGB image quality. A critical step in processing MS data is demosaicing, which reconstructs color information from the mosaic MS images captured by the camera. The embodiments are directed to a method for MS image demosaicing specifically designed for dual-camera setups where both RGB and MS cameras capture the same scene. The embodiments leverage co-captured RGB images, which typically have higher spatial fidelity, to guide the demosaicing of lower-fidelity MS images.

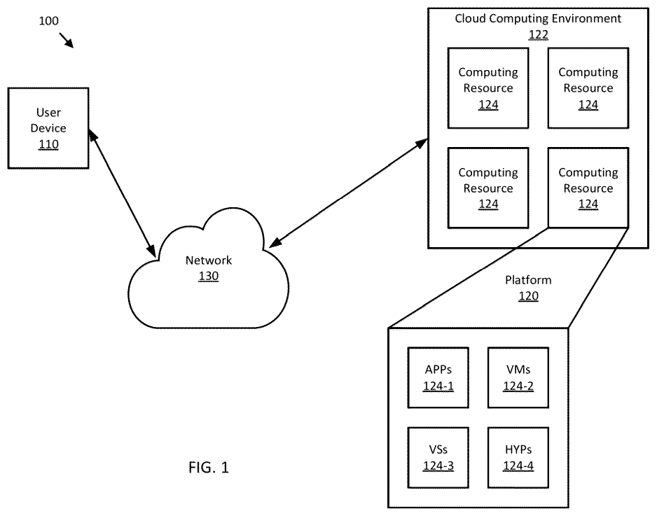

FIG. 1 is a diagram of an environment 100 in which methods, apparatuses, and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

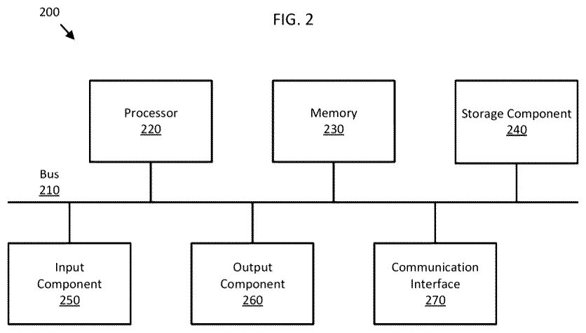

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more embodiments, MS image demosaicing is performed for dual-camera setups where both RGB and MS cameras capture the same scene. The embodiments leverage co-captured RGB images, which typically have higher spatial fidelity, to guide the demosaicing of lower-fidelity MS images.

MS imaging extends beyond standard RGB imaging by capturing spectral information across multiple wavelengths, often including visible and near-infrared spectra. MS imaging enables precise analysis for applications such as agriculture, medical imaging, and environmental monitoring. MS data has also shown great potential for image enhancement making it a valuable addition to imaging pipelines.

As multi-camera systems become more common in consumer devices, such as modern smartphones with asymmetric setups, integrating MS and RGB imaging has increased interest. MS sensors have been shown to enhance mobile imaging tasks such as illuminant spectral estimation, image restoration, low-light enhancement, and tone adjustment. However, most current methods leverage MS imaging as a complementary prior to improving RGB-targeted tasks rather than focusing on enhancing MS image quality directly. These features are primarily due to the lower fidelity typically associated with MS images (e.g., MS sensor has ˜400×400 pixels, while an RGB sensor has around ˜3000×4000 pixels), stemming from inherent challenges in the MS imaging pipeline. A standard RGB imaging pipeline adopts color filter arrays (CFAs) over the image sensor to capture red, green, and blue spectral bands. Each pixel records a single band, resulting in a single-channel mosaic raw image.

A commonly used CFA is the Bayer array, which arranges the bands in a 2×2 mosaic pattern. Demosaicing algorithms may then reconstruct the 3-channel RGB image by estimating the missing color values using the partial mosaic data. RGB demosaicing has been extensively studied, with classical approaches relying on signal processing and spatio-spectral priors, as well as more recent learning-based methods that often combine demosaicing and denoising tasks. These techniques achieve high-quality results by leveraging the dense spatial information available in RGB mosaics. In contrast, an MS imaging pipeline employs more complex multispectral filter arrays (MSFAs), often arranged in 4×4 mosaic patterns, to capture multiple spectral bands (e.g., 4×4 mosaic patterns captures 16 spectral bands). While MSFA provides richer spectral information, the increased number of bands results in sparser mosaic data, making the demosaicing process considerably more challenging than in RGB demosaicing.

To illustrate this concept, consider a practical example of smartphones integrating RGB and MS cameras in an asymmetric multi-camera setup. Both cameras share identical lenses and sensors in this configuration, with the RGB and MS cameras using the 2×2 Bayer CFA and 4×4 MSFA, respectively. Although both cameras capture mosaic raw images at the same resolution, MS demosaicing is inherently more complex, as it involves reconstructing more missing pixels per spectral band, leading to lower-fidelity MS image. Meanwhile, RGB demosaicing benefits from fewer missing pixels per color channel and denser spatial data, yielding higher-fidelity RGB images.

Accordingly, MS demosaicing is a challenging problem due to low sampling rates per color channel. This results in high-frequency information missing from an image. Current methods focus on MS demosaicing as a single sensor problem, but do not utilize information from other sensors. Furthermore, existing solutions for multi-sensor approaches don't handle demosaicing and fusion of information from another sensor.

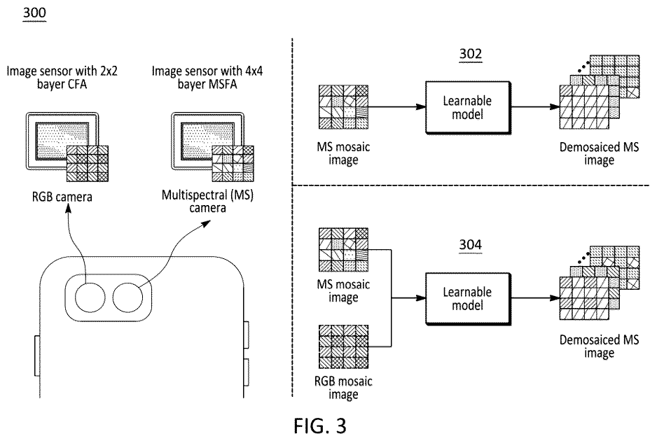

As a result, the embodiments are directed to a method for MS demosaicing. The embodiments leverage the increasing potential of integrating RGB and multispectral cameras within the same device. In particular, the RGB camera image, which generally offers higher spatial fidelity than the MS image, is used as the MSFA captures more spectral channels at the cost of spatial density compared to conventional RGB CFAs. The method uses the high-fidelity RGB image as guidance to reconstruct high-quality MS images, ensuring that the reconstructed MS images preserve rich spectral information and achieve the same resolution and spatial clarity as RGB counterparts. The MS demosaicing method leverages high-fidelity RGB images to address the low-fidelity nature of MS mosaic raw images, as illustrated in FIG. 3.

FIG. 3 illustrates an example dual camera setup 300 configured to implement a learning-based MS deomsaicing method. In one or more examples, the dual camera setup 300 may be in a mobile device equipped with both RGB and MS cameras. Unlike traditional MS demosaicing approaches 302, the embodiments 304 leverage the higher spatial resolution of the RGB mosaic from the RGB camera to guide and enhance the quality of the demosaiced MS image, achieving state-of-the-art results, as illustrated in FIG. 3.

In one or more examples, an RGB camera image may be used as guidance in MS demosaicing (304 of FIG. 3), using its higher spatial fidelity to compensate for the MS image captured with MSFAs, which trades spatial resolution for more spectral channels compared to RGB CFAs. Using the RGB camera ensures that the reconstructed MS images preserve rich spectral information and achieve the same resolution and spatial fidelity as the RGB counterparts.

The embodiments may include three separate components. First, initial demosaicing networks or a non-learning method may be used to provide intermediate MS/RGB images and features. Second, a “cross-spectral disparity estimation module” may be used to estimate disparity (or flow) between images, which may be labeled as cross-spectral as the input images in this case (MS and RGB) are from different color spaces. Third, a fusion module that takes this disparity estimate, the RGB/MS features, and images builds a final merged image based on these images. In one or more examples, in the fusion module, the disparity estimate may be used to warp the RGB image and features such that they are aligned with the MS image to be reconstructed. By utilizing the RGB and MS images together, the high spatial frequency detail from the RGB image may be used with the increased spectral information in the MS image.

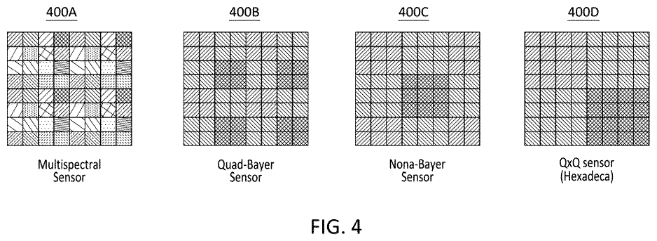

FIG. 4 illustrates a configuration of example sensors including a MS sensor 400A, a Quad-Bayer sensor 400B, a Nona-Bayer sensor 400C, or a Hexadeca sensor 400D or Q×Q sensor (Q>2) that capture images with patterns different than the traditional Bayer pattern. The mosaic images captured on these sensors may be demosaiced to reconstruct the full-color channel image. While the embodiments focus on the MS sensor case, the embodiments may be used on all sensors that suffer from low spatial sampling frequency.

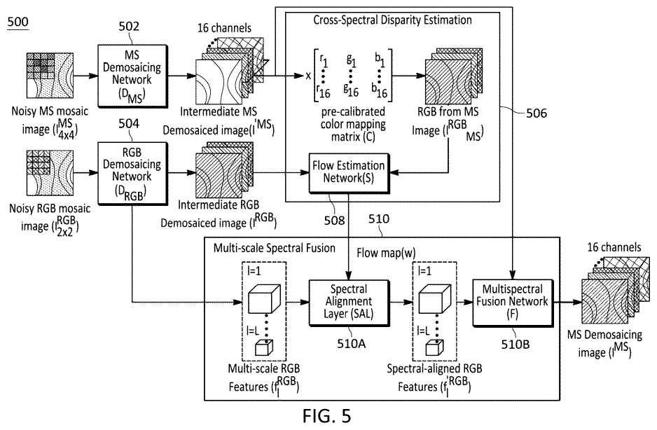

FIG. 5 illustrates an example MS demosaicing framework 500 configured to handle both MS and RGB mosaic images captured in asymmetric dual-camera setups. In one or more examples, the framework 500 takes MS and RGB mosaic images of the same scene captured with disparity, and produces a demosaiced MS image while utilizing high-fidelity details of the RGB image. In one or more examples, the framework 500 has two stages: demosaicing (502, 504) and fusion 510. In the first demosaicing stage, an MS demosaicing network 502 and an RGB demosaicing network 504 are employed to independently process the MS and RGB mosaic images, respectively.

In the fusion stage 510, a fusion module integrates the high-fidelity information from the demosaiced RGB image into the demosaiced MS image while addressing spectral differences and spatial disparities between the two images to produce the final demosaiced MS image with enhanced fidelity.

In one or more examples, the framework 500 enhances MS image demosaicing by integrating high-fidelity details from the co-captured RGB image. In one or more examples, in the demosaicing stage (502, 504), the MS and RGB networks, D_{MS} and D_{RGB}, reconstruct the MS and RGB images, I′^{MS} and I^{RGB}, respectively. In one or more examples, in the fusion stage 510, high-fidelity details from the RGB image are fused into the MS image, while addressing both geometric and spectral disparities.

In one or more examples, a Cross-Spectral Disparity Estimation module 506 computes dense correspondences w between MS and RGB images by first transforming the MS image into RGB color space to ensure spectral compatibility during flow estimation performed by a flow estimation network S 508. Then, a Spectral Alignment Layer (SAL) 510A refines multi-scale RGB demosaicing features

$${f}_{l}^{RGB} into {f}_{l}^{′ RGB} ,$$

simultaneously compensating for geometric and spectral differences to align them with the MS image. Finally, a Multispectral Fusion Network (F) 510B integrates refined RGB features

$$\begin{matrix}{f}_{l}^{′ RGB} into \\ {I}^{′MS} ,\end{matrix}$$

producing a high-fidelity MS image I^{MS}.

In one or more examples, in the demosaicing stage (502, 504), given the dual camera MS and RGB mosaic images,

$${I}_{4 \times 4}^{MS} ∈ {ℝ}^{H \times W} and {I}_{2 \times 2}^{RGB} ∈ {ℝ}^{H \times W} ,$$

the goal is to reconstruct their demosaiced images I′^{MS}∈ [symbol] ^{H×W×16} and I^{RGB}∈ [symbol] ^{H×W×3} using the demosaicing networks D_{MS} and D_{RGB}, respectively. In one or more examples, 4×4 and 2×2 denote the mosaic pattern for MS and RGB mosaic images, respectively, and H and W represent the height and width of the images.

The demosaiced images may be defined as follows:

### Eq. (1)

$$\begin{matrix}{I}^{′MS} = {D}_{MS} ( {I}_{4 \times 4}^{MS} ∈ {ℝ}^{H \times W} ) , \\ {I}^{RGB} = {D}_{RGB} ( {I}_{2 \times 2}^{RGB} ∈ {ℝ}^{H \times W} ) ,\end{matrix} \qquad Eq . ( 2 )$$

where NAFNet may be used as backbone networks for D_{MS} and D_{RGB}, selected based on their reliable performance in MS and RGB demosaicing tasks. In one or more examples, other network designs (e.g., U-Net, Restormer, . . . ) may be alternatively used as backbone networks for demosaicing.

In one or more examples, separate demosaicing may be performed for the MS and RGB mosaic images rather than attempting to fuse them directly. Aligning mosaic images with different patterns and spectral bands poses significant challenges that would complicate accurate fusion at the mosaic stage. By first reconstructing intermediate demosaiced images, a more precise and effective fusion can be facilitated in the subsequent stage.

The RGB image I^{RGB}∈ [symbol] ^{H×W×3} restored from 2×2 mosaics, captures high-fidelity details of a scene in contrast to the MS image I′^{MS}∈ [symbol] ^{H×W×16} reconstructed from 4×4 mosaics with sparser spectral data distribution. This sparsity limits the ability of the MS demosaicing network D_{MS} to recover fine details. In this stage, the goal is to transfer the high-fidelity details from I^{RGB} to I′^{MS}, and generating I^{MS} with enhanced details.

However, although I^{RGB} and I′^{MS} capture the same scene, it is not straightforward to directly utilize I^{RGB} for enhancing I′^{MS}, as the image pair is misaligned, due to the disparity introduced by the asymmetric dual-camera setup, and each image contains different spectral information.

To address this, the framework 500 includes two components: first, a Cross-Spectral Disparity Estimation module 506 computes dense-correspondences between I′^{MS} and I^{RGB} across different spectral channels; and second, a Multi-Scale Spectral Fusion Network 510B integrates high-fidelity details of I^{RGB} with fewer spectral bands into I′^{MS} with broader spectral range to produce a final MS image I^{MS}, while compensating for the disparity between the images.

Computing dense correspondence between images with different spectra (16-channel MS images I′^{MS} and 3-channel RGB images I^{RGB}) cannot be directly addressed by conventional methods. While some studies explore cross-modal matching, these studies are often limited to cases such as aligning RGB with Near InfraRed, InfraRed, or RGB under varying illuminations. An alternative for aligning RGB with MS images uses an additional RGB proxy camera to generate pseudo-ground-truths for alignment learning. However, this approach requires an extra camera, which is not feasible in our RGB-MS dual-camera setup. Instead, the embodiments provide solution for cross-spectral disparity estimation between I′^{MS} and I^{RGB}.

In one or more examples, a pre-calibrated color conversion matrix C∈ [symbol] ^{16×3} may be used to transform I′^{MS}∈ [symbol] ^{H×W×16} into I^{RGB}^{_{MS}}∈ [symbol] ^{H×W×3}, aligning it to the color space of the RGB image I^{RGB} These features may be represented as:

$${I}^{{RGB}_{MS}} = {r}^{- 1} ( r ( {I}^{′ MS} ) \times C ) , \qquad Eq . ( 3 )$$

where r(I′^{MS}∈ [symbol] ^{H×W×16})→I′^{MS}∈ [symbol] ^{(H×W)×16} is a reshaping operator and the color conversion matrix C is pre-calibrated by computing a least squares transformation between the RGB and MS color chart image pairs.

Subsequently, the optical flow w∈ [symbol] ^{H×W×2} between I^{RGB}^{_{MS}} and I^{RGB} may be represented using the pre-trained flow estimation network S 508. In one or more embodiments, a RAFT optical flow network may be used, but alternative optical flow networks may be used. In one or more examples, w may be obtained as:

$$w = S ( {I}^{{RGB}_{MS}} , {I}^{RGB} ) . \qquad Eq . ( 4 )$$

In one or more examples, the flow estimation network S 508 may first preprocess I^{RGB} and I^{RGB}^{_{MS}}, mapping them into the sRGB color space using corresponding camera metadata (e.g., white balance and color correction matrices) to align the images with the color space used for the flow estimation task. The estimated flow w contains per-pixel flow offsets representing the displacement from I′^{MS} to I^{RGB}, which may be used later in the fusion process for compensating geometric misalignment between the two images.

During multi-scale spectral fusion, in one or more examples, the high-fidelity details of the RGB image I^{RGB} may be fused into the MS image I′^{MS} to produce the final MS image I^{MS} while compensating for the disparity between the two images using the estimated flow map w. Integrating I^{RGB}, which may be captured with fewer spectral bands (e.g., 3 channels), into I^{MS} captured with a broader range of spectral bands, is not easily performed, as specific signals captured in an MS spectral band may be absent in RGB bands. In one or more examples, a multi-scale spectral fusion network F may be provided to address this challenge. The network F takes I′^{MS} as its primary input to produce the final enhanced output I^{MS}. A spectral alignment layer (SAL) is introduced to incorporate details from the RGB image. The layer takes L-level multi-scale RGB feature maps

$$\begin{matrix}\{ {f}_{l}^{RGB} , l ∈ \\ [ 1 , 2 , … , L ] \}\end{matrix}$$

extracted from the RGB demosaicing network and flow map w to provide refined RGB feature map

$${f}_{l}^{′ RGB}$$

to each level of the fusion network F.

In one or more examples, the fusion process may be defined as follows:

$${f}_{l}^{′ RGB} = SAL ( {f}_{l}^{RGB} , w ) , \qquad Eq . ( 5 )$$

$${I}^{MS} = F ( {I}^{′ MS} , {f}_{l ∈ [ 1 , 2 , … , L ]}^{′ , RGB} ) , \qquad Eq . ( 6 )$$

where Restormer is adopted as the backbone for the network F. As understood by one of ordinary skill in the art, Restormer is an encoder-decoder Transformer for multi-scale local-global representation learning on high-resolution images without disintegrating them into local windows to exploit distant image context. Alternative image restoration networks can be used in different designs. In one or more examples, the refined RGB feature maps

$${f}_{l}^{′ RGB} ,$$

are aligned with the MS image and adapted for spectral compatibility, facilitating their fusion with the intermediate MS features within the network F.

In one or more examples, SAL produces refined RGB feature maps

$${f}_{l}^{′ RGB}$$

that geometrically align with the MS features and are spectrally compatible with the intermediate MS features of the backbone network F.

Geometric and spectral disparities are addressed simultaneously using the deformable convolution network (DCN), which integrates seamlessly with the flow map w and is particularly effective at capturing spatial features through adaptive sampling patterns.

In one or more examples, SAL may compute the refined RGB feature map

$${f}_{l}^{′ RGB}$$

based on the following:

$${f}_{l}^{′ RGB} ( p ) = {\sum }_{i ∈ Ω} k ( i ) \cdot {f}_{l}^{RGB} ( p + {p}_{1} + i + Δ i ) , \qquad Eq . ( 7 )$$

where p is the location on the output feature map

$${f}_{l}^{′ RGB} ,$$

and i enumerates the locations Ω in the deformable convolution kernel k. The optical flow offset at location p, denoted as p_{w}=w(p)/2^{l-1}, represents the MS-to-RGB image displacement downscaled by 2^{l-1}, enabling multi-scale geometric alignment of RGB to MS features.

In one or more examples, Δi represents the deformable kernel offsets learned by SAL, enabling the convolution kernel k to adapt spatially and capture fine structural details in the multi-scale RGB features

$${f}_{l}^{′ RGB} ,$$

such as edges and textures, mat align more effectively with the broader spectral features of the MS image. By addressing both geometric and spectral disparities, the refined RGB features

$${f}_{l}^{′ RGB}$$

after SAL become highly complementary to the MS bands, facilitating improved alignment and fusion. As a result, the final MS image I^{MS} is advantageously produced with enhanced detail and visual coherence, leveraging the high-fidelity structural information from the RGB image and the rich spectral data from the MS image.

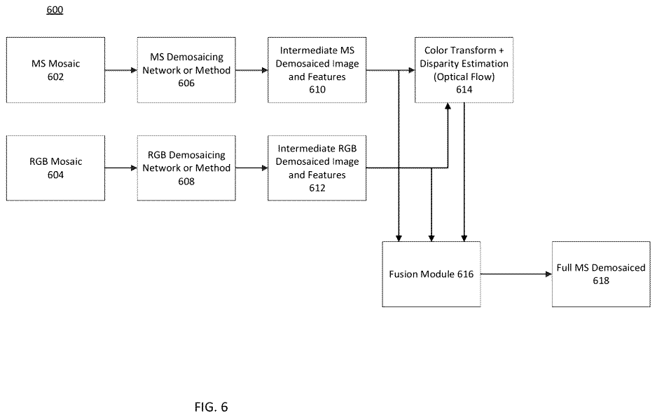

FIG. 6 illustrates an example process 600 for MS demosaicing that utilizes images from another sensor such as an RGB mosaic. The process 600 may be performed using the framework 500 illustrated in FIG. 5. In one or more examples, a MS mosaic 602 and RGB mosaic 604 are captured in a side-by-side setup where there may be a slight misalignment. Initial demosaicing (606, 608) may be performed to compute intermediate images (610, 612). The disparity between the images may be estimated 614. This module may handle the different color spaces of both images and then output the optical flow. Finally, the information from the earlier stages may be fused 616 using the optical flow estimated with a fusion module, which results in a final MS demosaiced image 618.

The framework may be implemented in three stages: demosaicing, alignment, and fusion.

In the first demosaicing stage, two models may be employed to independently process the MS and RGB mosaic images. In the alignment stage, the spatial disparities may be estimated between both images. In the fusion stage, a fusion module integrates the high-fidelity information from the demosaiced RGB image into the demosaiced MS image while addressing spatial disparities and spectral differences between the two images to produce the final demosaiced MS image with enhanced fidelity.

### Stage 1: RGB and MS Demosaicing

In this stage, given the dual camera MS and RGB mosaic images, the demosaiced images are reconstructed. In one or more examples NAFNet may be employed as backbone networks, selected based on their reliable performance in MS and RGB demosaicing tasks. In one or more examples, separate demosaicing for the MS and RGB mosaic images may be performed to enable more precise and effective fusion in the subsequent stage, rather than attempting to fuse them directly. Aligning mosaic images with different patterns and spectral bands presents significant challenges, complicating the accurate fusion of MS and RGB images.

### Stage 2: Alignment Stage (Cross-Spectral Disparity Estimation)

As understood by one of ordinary skill in the art, the RGB image captures more high-frequency spatial details of a scene in contrast to the MS image. In this stage, the high-frequency spatial details may be transferred to help generate the MS image with enhanced details.

Although the RGB and MS images capture the same scene, it is not an easy process to directly utilize the RGB image for enhancing the MS image, as the image pair is misaligned, due to the disparity introduced within the dual-camera setup, and each image contains different spectral information. In one or more examples, the cross-spectral disparity estimation stage computes dense-correspondences between the MS and RGB images. This estimation may be performed by converting the MS image into an RGB color space utilizing a pre-calibrated color mapping matrix. After this estimation is performed, both images are now in an RAW-RGB space. In one or more examples, the optical flow network may be RAFT to estimate the flow. As understood by one of ordinary skill in the art, RAFT is trained in sRGB and thus, both RAW images may be processed through an image signal processor to get sRGB images that may be used to estimate the flow.

### Stage 3: Fusion Stage (Multi-Scale Spectral Fusion)

The fusion stage may integrate high-frequency spatial details of the RGB image with fewer spectral bands into the MS image with more spectral measurements to produce a final MS image, while compensating for the disparity between the images. The embodiments are directed to a multi-scale spectral fusion network to address this challenge. The fusion network takes the intermediate MS demosaiced image, as its primary input to produce the final enhanced output. In one or more examples, the SAL may be used to incorporate details from the RGB image. This layer may take L-level multi-scale RGB feature maps extracted from the RGB demosaicing network and flow map from the alignment stage to provide refined RGB feature map to each level of the fusion network.

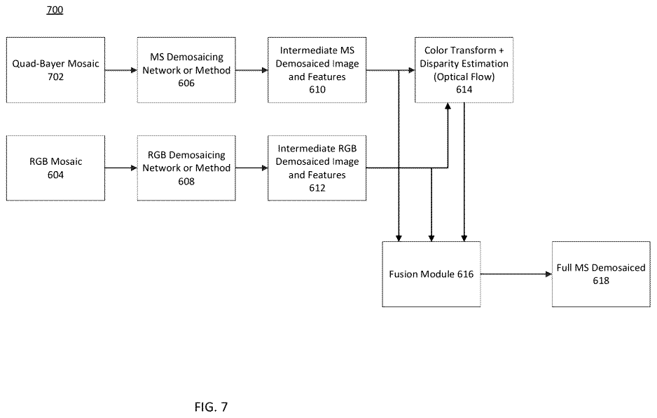

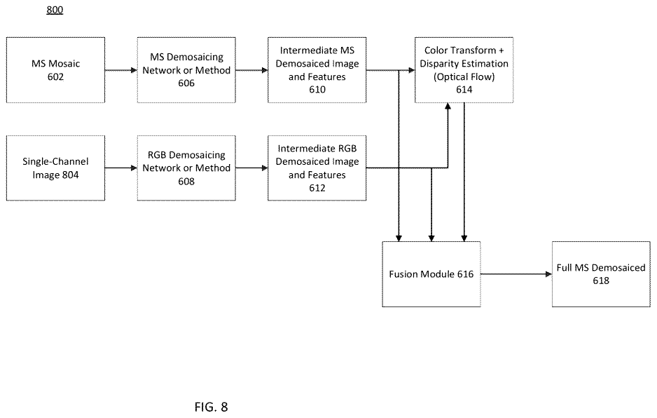

FIG. 7 illustrates an example process 700 in which the MS sensor 602 is replaced with a quad-bayer sensor 702. FIG. 8 illustrates an example process 800 in which the RGB sensor 604 is replaced with a single-channel sensor 804.

In one or more examples, a training process includes two stages: demosaicing and fusion. To train the network, a dual-camera RGB-MS dataset may be used. The dataset may include quadruplets of mosaic MS and RGB images, each paired with ground-truth demosaic MS and RGB images, denoted as

$${I}_{4 \times 4}^{MS} , {I}_{2 \times 2}^{RGB} , {\hat{I}}^{MS} , and {\hat{I}}^{RGB} ,$$

respectively.

In one or more examples, the MS and RGB demosaicing networks D_{MS} and D_{RGB} are first trained independently. For D_{MS}, the L2 loss may be trained between the predicted MS demosaiced image I′^{MS}, and the ground-truth MS image Î^{MS}. Similarly, for the network D_{RGB}, the L2 loss between the predicted RGB image I^{RGB}, and the ground-truth RGB image Î^{RGB} may applied.

In this stage, the multi-scale spectral fusion module is trained, which comprises the spectral alignment layer (SAL) and the fusion network F to incorporate high-fidelity details from I^{RGB} into the demosaiced MS image I′^{MS}, producing an enhanced MS image I^{MS}. The MS and RGB demosaicing networks and the optical flow estimation network, S, may remain fixed during this stage. An L2 loss may be applied between the final MS image I^{MS} and the ground-truth MS image Î^{MS}.

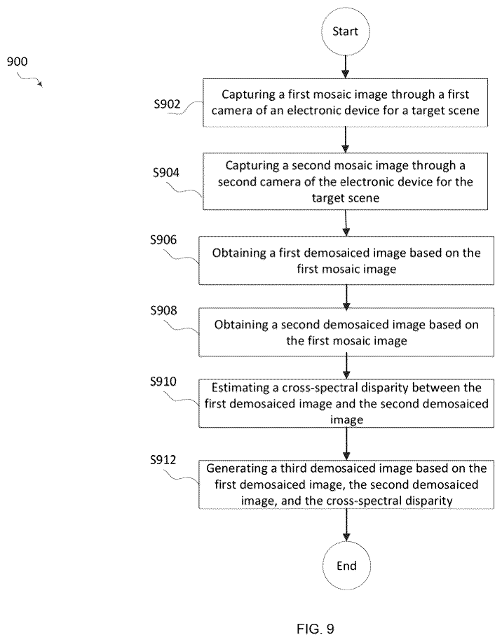

FIG. 9 illustrates an example process 900 for generating an MS demosaiced image. The process 900 may be performed using the dual camera setup 300 (FIG. 3) and the framework 500 (FIG. 5). Although the operations illustrated in FIG. 9 are illustrated sequentially, one or more operations may be performed in parallel where one operation may be started before a prior operation is completed.

The process 900 may start at operation S902 where a first mosaic image is captured through a first camera of an electronic device for a target scene. At operation S904, a second mosaic image may be captured through a second camera of the electronic device for the target scene. In one or more examples, the first camera may include an MS sensor in which the first mosaic image is an MS mosaic image, and the second camera may include an RGB sensor in which the second mosaic image is an RGB mosaic image. In one or more examples, the first and second cameras may include any combination of sensors illustrated in FIG. 4 (e.g., first camera may include a quad-bayer sensor and the second camera may be a nona-bayer sensor).

The process 900 proceeds to operation S906 in which a first demosacied image is obtained based on the first mosaic image. At operation S908, a second demosaiced image is obtained based on the second mosaic image. In one or more examples, operation S906 may be performed using the MS Demosaicing Network 502 (FIG. 5), and operation S908 may be performed using the RGB demosaicing network 504 (FIG. 5).

The process 900 proceeds to operation S910 in which a cross-spectral disparity between the first demosaiced imaged and the second demosaiced image is estimated. In one or more examples, the cross-spectral disparity may be estimated using the Cross-spectral Disparity Estimation module 506 (FIG. 5).

The process 900 proceeds to operation S912 where a third demosaiced image is generated based on the first demosaiced image, the second demosaiced image, and the cross-spectral disparity. In one or more examples, the third demosaiced image may be a final demosaiced image generated using the fusion stage 510 (FIG. 5).

In one or more examples, to train and validate the network, a dataset containing quadruplets of mosaiced RGB and MS images, each paired with ground-truth demosaiced RGB and MS images may be used.

Representative examples: may include 28 scenes staged in an illumination box, and samples of quadruplets captured from scenes 7, 14, 21, and 28. Each quadruplet may include a 1-channel RGB mosaic image, and the corresponding 3-channel RGB demosaiced ground-truth, a 1-channel MS mosaic image, its corresponding 16-channel MS demosaiced ground-truth. The images within each quadruplet may share the same spatial resolution.

The ground-truth demosaiced images are high-quality captures obtained using an imaging system that simulates an asymmetric dual-camera setup. The system simulates an RGB camera capturing a scene in 3 RGB channels and an MS camera capturing the same scene in 16 multispectral channels, with a spatial disparity between them. The mosaic images are synthesized by converting the demosaiced images into 1-channel mosaics. The dataset comprises 502 quadruplets across 28 challenging scenes with high textures and detailed features.

The dataset has training, validation, and test sets, containing 352, 47, and 103 image quadruplets captured from 20, 2, and 6 scenes, respectively, where each image is in camera raw space at the resolution of 1440×2160 pixels. The embodiments, designed for handheld devices like smartphones with minimal multi-camera disparity, led to collecting a dataset with realistic disparity and accurate ground-truth demosaic images. It includes both RGB and synthetic MS images in raw space, with no processing from the camera pipeline, making it ideal for training and evaluating our approach in the early stages of the onboard camera pipeline.

In one or more examples, to collect the dataset, an imaging system including a camera mounted on a linear stage actuator and a controllable illumination box that allows a simulation of an asymmetric dual-camera setup may be used, where MS and RGB cameras have a constant relative baseline. The linear stage actuator moves the camera to two adjustable positions, one for MS capture and the other for RGB capture. A microcontroller may be used to precisely control the camera movement between positions, ensuring a constant relative baseline between MS and RGB captures (e.g., baseline of 1 cm). The controllable illumination box simulates multispectral data capturing, featuring configurable light sources that distribute evenly throughout the scene within the box. Capturing occurs in a lab setting in a dark room to ensure that the box is the sole lighting source. For each capture, the system generates a pair of 16-channel MS and 3-channel RGB demosaic images using the pixel shift mode featured in the camera, which shifts the sensor during capture to enable sensor-level demosaicing.

Each image is initially captured at a resolution of 5760× 8640 pixels. To mitigate noise introduced by the small pixel size of the sensor, these images are downsampled to a resolution of 1440×2160 pixels to generate ground-truth demosaiced images.

The 1-channel MS and RGB input mosaic images are created by applying a 4×4 MSFA pattern and 2×2 Bayer CFA pattern to the MS and RGB ground-truth demosaiced images, respectively. Furthermore, noise may be simulated on the mosaic images using a Poisson-Gaussian noise model, calibrated at ISO 400. For this calibration, images of a color chart (e.g., 30 images taken at three different exposures) captured by the camera may be used.

The camera in the system uses a CFA that captures the RGB spectrum, making RGB image acquisition straightforward. RGB images are obtained by configuring the light sources within the controllable illumination box to simulate the CIE D65 daylight illuminant. For MS image acquisition, an MSFA is simulated by capturing multiple RGB images of a scene under varying light sources. The following provides further background for simulating MS capture using the illumination box.

In one or more examples, the image formation process may be considered under a uniform light source across the scene. The color information of a mosaic image/at location x may be defined as:

$$I ( x ) = {\int }_{γ} S ( y ) {C}_{rgb} ( x , y ) L ( y ) R ( x , y ) dy + z , \qquad Eq . ( 8 )$$

where S(y), C_{rgb}(⋅), L(⋅), and R(⋅) represent the response function of a sensor, RGB CFA response function, the spectral power distribution (SPD) of light, and the scene reflectance, respectively. z denotes unwanted noise, typically characterized by signal-dependent and additive components. The integral over the visible range y at wavelength y provides the color information in the mosaic raw image. An additional virtual light source is introduced with an SPD denoted as J(⋅), which is constant across all scenes and uniform throughout the visible spectrum.

Equation (8) may be rewritten as follows:

$$I ( x ) = {\int }_{γ} S ( y ) {C}_{rgb} ( x , y ) L ( y ) J ( y ) R ( x , y ) dy + z . \qquad Eq . ( 9 )$$

The capturing system uses the illumination box as the only light source in the scene. The box allows control over the SPD of the light, enabling the simulation of the MS mosaic image using the RGB CFA. By rewriting the previous equation, the response function of the CFA is combined with the SPD of the scene light (excluding the introduced virtual light source) as follows:

$$I ( x ) = {\int }_{γ} S ( y ) C ( x , y ) J ( y ) R ( x , y ) dy + z , \qquad Eq . ( 10 )$$

where C(x, y), represents the response function of an arbitrary color filter under the assumption that the SPD of the light source in a scene is only J, and uniform across all scenes throughout the visible spectrum. This formulation allows synthetically generating different color filter responses by varying the SPD of light within the illumination box, thereby creating MSFA responses.

The box provides seven primary wavelengths, ranging from 380 nm to 760 nm, which can be combined in various ways to create customizable light sources. For MS image acquisition, the system captures the same scene seven times, each under a different wavelength combination, resulting in a 21-channel MS image (7 wavelength combinations×3 RGB channels). This is then reduced to a 16-channel MS image by discarding the 5 spectral channels with the least information.

The above disclosure also encompasses the embodiments listed below:
(1) A method performed by at least one processor of an electronic device, the method including: capturing a first mosaic image through a first camera of the electronic device for a target scene; capturing a second mosaic image through a second camera of the electronic device for the target scene; obtaining a first demosaiced image based on the first mosaic image; obtaining a second demosaiced image based on the second mosaic image; estimating a cross-spectral disparity between the first demosaiced image and the second demosaiced image; and generating a third demosaiced image based on the first demosaiced imaged, the second demosaiced image, and the cross-spectral disparity.
(2) The method according to feature (1), in which the first camera is an RGB camera, the first mosaic image is a red-green-blue (RGB) mosaic image, and the first demosaiced image is an RGB demosaiced imaged.
(3) The method according to feature (2), in which the second camera is a multi-spectral (MS) camera, the second image is an MS mosaic image, and the second demosaiced image is an MS demosaiced image.
(4) The method of feature (3), in which the MS camera includes a MS sensor, a quad-bayer sensor, a nona-bayer sensor, or a Q×Q (Q>2) sensor.
(5) The method of any one of features (2)-(4), in which the RGB camera comprises a bayer sensor.
(6) The method of any one of features (2)-(5), in which the RGB camera comprises a single color filter.
(7) The method according to any one of features (3)-(6), in which the estimating the cross-spectral disparity between the first demosaiced image and the second demosaiced image further includes: converting the MS demosaiced image into an RGB color space using a pre-defined color mapping matrix; and obtaining an optical flow that indicates the cross-spectral disparity through a flow estimation network based on the converted MS demosaiced image and the RGB demosaiced image.
(8) The method according to any one of features (3)-(7), in which the generating the third demosaiced image further includes: obtaining a multi-scale RGB feature from the RGB mosaic image; obtaining a spectral aligned RGB feature based on the multi scale RGB feature and the estimated cross-spectral disparity; and generating the third demosaiced image as a final MS demosaiced image by fusing the spectral aligned RGB feature and the MS demosaiced image.
(9) An electronic device includes: memory storing one or more instructions; a processor operatively coupled to the memory, in which the instructions, when executed by the processor, cause the electronic device to: capture a first mosaic image through a first camera of the electronic device for a target scene; capture a second mosaic image through a second camera of the electronic device for the target scene; obtain a first demosaiced image based on the first mosaic image; obtain a second demosaiced image based on the second mosaic image; estimate a cross-spectral disparity between the first demosaiced image and the second demosaiced image; and generate a third demosaiced image based on the first demosaiced imaged, the second demosaiced image, and the cross-spectral disparity.
(10) The electronic device according to feature (9), in which the first camera is an RGB camera, the first mosaic image is a red-green-blue (RGB) mosaic image, and the first demosaiced image is an RGB demosaiced imaged.
(11) The electronic according to feature (9) or (10), in which the second camera is a multi-spectral (MS) camera, the second image is an MS mosaic image, and the second demosaiced image is an MS demosaiced image.
(12) The electronic device of feature (11), in which the MS camera includes a MS sensor, a quad-bayer sensor, a nona-bayer sensor, or a Q×Q (Q>2) sensor.
(13) The electronic device of any one of features (10)-(12) in which the RGB camera comprises a bayer sensor.
(14) The electronic device of features (10)-(13), in which the RGB camera comprises a single color filter.
(15) The electronic according to any one of features (11)-(14), in which the one or more instructions, when executed by the processor, further cause the electronic device, to estimate the cross-spectral disparity between the first demosaiced image and the second demosaiced image, to: convert the MS demosaiced image into an RGB color space using a pre-defined color mapping matrix; and obtain an optical flow that indicates the cross-spectral disparity through a flow estimation network based on the converted MS demosaiced image and the RGB demosaiced image.
(16) The electronic device according to any one of features (11)-(15), in which the one or more instructions, when executed by the processor, further cause the electronic device, to generate the third demosaiced image, to: obtain a multi-scale RGB feature from the RGB mosaic image; obtain a spectral aligned RGB feature based on the multi scale RGB feature and the estimated cross-spectral disparity; and generate the third demosaiced image as a final MS demosaiced image by fusing the spectral aligned RGB feature and the MS demosaiced image.
(17) A non-transitory computer readable medium having instructions stored therein, which when executed by a processor in an electronic device cause the electronic device to perform a method including: capturing a first mosaic image through a first camera of the electronic device for a target scene; capturing a second mosaic image through a second camera of the electronic device for the target scene; obtaining a first demosaiced image based on the first mosaic image; obtaining a second demosaiced image based on the second mosaic image; estimating a cross-spectral disparity between the first demosaiced image and the second demosaiced image; and generating a third demosaiced image based on the first demosaiced imaged, the second demosaiced image, and the cross-spectral disparity.
(18) The non-transitory computer readable medium according to feature (17), in which the first camera is an RGB camera, the first mosaic image is a red-green-blue (RGB) mosaic image, and the first demosaiced image is an RGB demosaiced imaged.
(19) The non-transitory computer readable medium according to feature (17) or (18), in which the second camera is a multi-spectral (MS) camera, the second image is an MS mosaic image, and the second demosaiced image is an MS demosaiced image.
(20) The non-transitory computer readable medium according to feature (19), in which the MS camera includes a MS sensor, a quad-bayer sensor, a nona-bayer sensor, or a Q×Q (Q>2) sensor.

What is claimed is:

1. A method performed by at least one processor of an electronic device, the method comprising:
capturing a first mosaic image through a first camera of the electronic device for a target scene;
capturing a second mosaic image through a second camera of the electronic device for the target scene;
obtaining a first demosaiced image based on the first mosaic image;
obtaining a second demosaiced image based on the second mosaic image;
estimating a cross-spectral disparity between the first demosaiced image and the second demosaiced image; and
generating a third demosaiced image based on the first demosaiced imaged, the second demosaiced image, and the cross-spectral disparity.

2. The method according to claim 1, wherein the first camera is an RGB camera, the first mosaic image is a red-green-blue (RGB) mosaic image, and the first demosaiced image is an RGB demosaiced imaged.

3. The method according to claim 2, wherein the second camera is a multi-spectral (MS) camera, the second image is an MS mosaic image, and the second demosaiced image is an MS demosaiced image.

4. The method of claim 3, wherein the MS camera includes a MS sensor, a quad-bayer sensor, a nona-bayer sensor, or a Q×Q (Q>2) sensor.

5. The method of claim 2 wherein the RGB camera comprises a bayer sensor

6. The method of claim 2, wherein the RGB camera comprises a single color filter.

7. The method according to claim 3, wherein the estimating the cross-spectral disparity between the first demosaiced image and the second demosaiced image further comprises:
converting the MS demosaiced image into an RGB color space using a pre-defined color mapping matrix; and
obtaining an optical flow that indicates the cross-spectral disparity through a flow estimation network based on the converted MS demosaiced image and the RGB demosaiced image.

8. The method according to claim 3, wherein the generating the third demosaiced image further comprises:
obtaining a multi-scale RGB feature from the RGB mosaic image;
obtaining a spectral aligned RGB feature based on the multi scale RGB feature and the estimated cross-spectral disparity; and
generating the third demosaiced image as a final MS demosaiced image by fusing the spectral aligned RGB feature and the MS demosaiced image.

9. An electronic device comprising:
memory storing one or more instructions;
a processor operatively coupled to the memory,
wherein the instructions, when executed by the processor, cause the electronic device to:
capture a first mosaic image through a first camera of the electronic device for a target scene;
capture a second mosaic image through a second camera of the electronic device for the target scene;
obtain a first demosaiced image based on the first mosaic image;
obtain a second demosaiced image based on the second mosaic image;
estimate a cross-spectral disparity between the first demosaiced image and the second demosaiced image; and
generate a third demosaiced image based on the first demosaiced imaged, the second demosaiced image, and the cross-spectral disparity.

10. The electronic device according to claim 9, wherein the first camera is an RGB camera, the first mosaic image is a red-green-blue (RGB) mosaic image, and the first demosaiced image is an RGB demosaiced imaged.

11. The electronic according to claim 9, wherein the second camera is a multi-spectral (MS) camera, the second image is an MS mosaic image, and the second demosaiced image is an MS demosaiced image.

12. The electronic device of claim 11, wherein the MS camera includes a MS sensor, a quad-bayer sensor, a nona-bayer sensor, or a Q×Q (Q>2) sensor.

13. The electronic device of claim 10 wherein the RGB camera comprises a bayer sensor

14. The electronic device of claim 10, wherein the RGB camera comprises a single color filter.

15. The electronic according to claim 11, wherein the one or more instructions, when executed by the processor, further cause the electronic device, to estimate the cross-spectral disparity between the first demosaiced image and the second demosaiced image, to:
convert the MS demosaiced image into an RGB color space using a pre-defined color mapping matrix; and
obtain an optical flow that indicates the cross-spectral disparity through a flow estimation network based on the converted MS demosaiced image and the RGB demosaiced image.

16. The electronic device according to claim 11, wherein the one or more instructions, when executed by the processor, further cause the electronic device, to generate the third demosaiced image, to:
obtain a multi-scale RGB feature from the RGB mosaic image;
obtain a spectral aligned RGB feature based on the multi scale RGB feature and the estimated cross-spectral disparity; and
generate the third demosaiced image as a final MS demosaiced image by fusing the spectral aligned RGB feature and the MS demosaiced image.

17. A non-transitory computer readable medium having instructions stored therein, which when executed by a processor in an electronic device cause the electronic device to perform a method comprising:
capturing a first mosaic image through a first camera of the electronic device for a target scene;
capturing a second mosaic image through a second camera of the electronic device for the target scene;
obtaining a first demosaiced image based on the first mosaic image;
obtaining a second demosaiced image based on the second mosaic image;
estimating a cross-spectral disparity between the first demosaiced image and the second demosaiced image; and
generating a third demosaiced image based on the first demosaiced imaged, the second demosaiced image, and the cross-spectral disparity.

18. The non-transitory computer readable medium according to claim 17, wherein the first camera is an RGB camera, the first mosaic image is a red-green-blue (RGB) mosaic image, and the first demosaiced image is an RGB demosaiced imaged.

19. The non-transitory computer readable medium according to claim 18, wherein the second camera is a multi-spectral (MS) camera, the second image is an MS mosaic image, and the second demosaiced image is an MS demosaiced image.

20. The non-transitory computer readable medium according to claim 19, wherein the MS camera includes a MS sensor, a quad-bayer sensor, a nona-bayer sensor, or a Q×Q (Q>2) sensor.
